(19) United States
(12) Patent Application Publication
(10) Pub. No.: US 2009/0113645 A1
(43) Pub. Date: May 7, 2009

(54) METHOD OF COUPLING PIPELINE PIGS TO FORM AN ARTICULATED PIPELINE PIG ASSEMBLY

(76) Inventor: Kristopher Kurbis, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/265,104

(22) Filed: Nov. 5, 2008

(30) Foreign Application Priority Data
Nov. 6, 2007 (CA) 2609581

(51) Int. Cl. B08B 9/04

(52) U.S. Cl. 15/104.061

(57) ABSTRACT

A method of coupling pipeline pigs to form an articulated pipeline pig assembly. A first step involves providing more than one pipeline pig, the more than one pipeline pig having couplers which couple upon impact and allow for limited articulation upon coupling. A second step involves launching each pipeline pig individually into a carrier pipe. A third step involves bringing the more than one pipeline pig into contact within the carrier pipe after launching to cause the couplers on each pipeline pig to couple with another pipeline pig upon impact, thereby forming an articulated pipeline pig assembly of more than one pipeline pig.

### FIELD

The present invention relates to a method of coupling pipeline pigs to form an articulated pipeline pig assembly, and a pipeline pig assembly in accordance with the teachings of the method.

### BACKGROUND

Articulated pipeline pig assemblies are known in the art. United Kingdom Patent 2,265,433 (Freud) and International Patent Publication WO/95/33584 (Somnier et al) are examples of articulated pipeline pig assemblies.

### SUMMARY

There is provided a method of coupling pipeline pigs to form an articulated pipeline pig assembly. A first step involves providing more than one pipeline pig, the more than one pipeline pig having couplers which couple upon impact and allow for limited articulation upon coupling. A second step involves launching each pipeline pig individually into a carrier pipe. A third step involves bringing the more than one pipeline pig into contact within the carrier pipe after launching to cause the couplers on each pipeline pig to couple with another pipeline pig upon impact, thereby forming an articulated pipeline pig assembly of more than one pipeline pig.

### BRIEF DESCRIPTION OF THE DRAWINGS

These and other features will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view of two pipeline pigs forming an articulated pipeline assembly.

FIG. 2 is a side elevation view of another embodiment of two pipeline pigs forming an articulated pipeline assembly.

FIG. 3 is a detailed side elevation view of a mating engagement between a male coupler and a female coupler of the articulated pipeline assembly illustrated in FIG. 2, in a straight orientation.

FIG. 4 is a detailed side elevation view of a mating engagement between a male coupler and a female coupler of the articulated pipeline assembly illustrated in FIG. 2, in an angular orientation.

FIG. 5 is a detailed end view, partially in section, of the female coupler from FIG. 2.

FIG. 6 is a detailed side elevation view of the male coupler and female coupler of the articulated pipeline assembly illustrated in FIG. 2, prior to mating.

FIG. 7 is a side elevation view of an individual pipeline pig being launched into a carrier pipe.

FIGS. 8-9 are side elevation views of the individual pipeline pigs being coupled by impact within the carrier pipe to form the articulated pipeline assembly.

### DETAILED DESCRIPTION

An articulated pipeline pig assembly generally identified by reference numeral 10, will now be described with reference to FIG. 1 through 9.

Structure and Relationship of Parts:

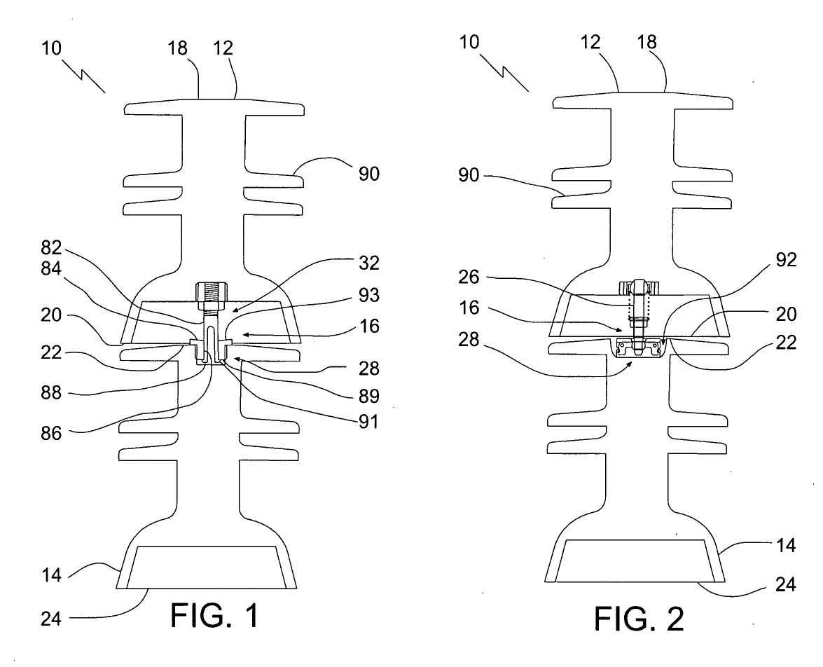

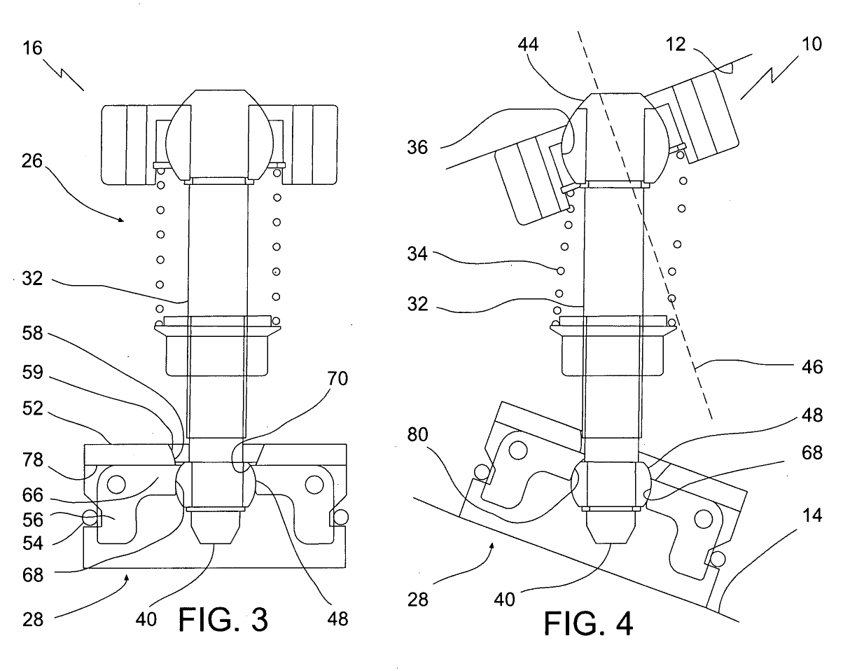

Referring to FIGS. 1 and 2, an articulated pipeline pig assembly 10 is shown having a first pipeline pig 12, a second pipeline pig 14, and a coupling system 16. First pig 12 has a first end 18 and a second end 20. Second pig 14 has a first end 22 and a second end 24. Referring to FIG. 3, coupling system 16 consists of a male coupler 26 and a female coupler 28. Referring to FIG. 2, male coupler 26 is attached at second end 20 of first pig 12, and female coupler 28 is attached at first end 22 of second pig 14. Coupling system 16 is designed to couple first and second pigs 12 and 14, respectively, together upon impact and allow for limited articulation.

Referring to FIG. 6, male coupler 26 consists of a base 30, and a spring 34. Male coupler 26 is shown as a male member 32. Alternatively, male and female couplers 26 and 28 may be any type of couplers known in the prior art. Base 30 consists of a curved seat 36. Male member 32 has a base end 38, an engaging end 40, and a shoulder 42. Base end 38 of male member 32 may be provided as a pivoting ball 44. Pivoting ball 44 fits neatly into curved seat 36 of base 30, allowing male member 32 to pivot. Spring 34 extends from base 30 and attaches to shoulder 42 of male member 32. Shoulder 42 is attached to male member 32 between base end 38 and engaging end 40. Alternatively, spring 34 may attach directly to male member 32. Spring 34 biases male member 32 into an orientation along an axis 46 of first pipeline pig 12 (shown in FIG. 2). A first engagement surface 48 may be provided at or near engaging end 40. First engagement surface 48 may be curved and generally spherical as shown.

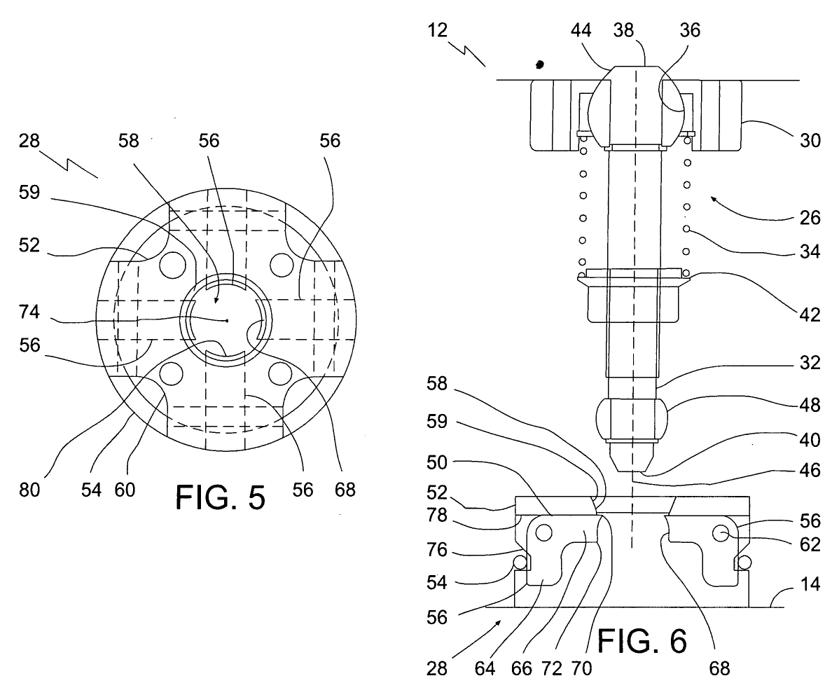

Referring to FIG. 6, female coupler 28 has a locking seat 50, a base plate 52, and an O-ring 54. Locking seat 50 consists of pivoting dogs 56. Referring to FIG. 5, four of pivoting dogs 56 are spaced at regular intervals around female coupler 28. Alternatively, other numbers of pivoting dogs 56 may be provided. Base plate 52 consists of an engagement hole 58, and conical guide walls 59. Hole 58 is substantially circular, and provides an entryway for male member 32 (shown in FIG. 6) to enter female coupler 28. Referring to FIG. 3, conical guide walls 59 are positioned around hole 58, conical guide walls 59 being angled in order to guide male member 32 into engagement with female coupler 28. Referring to FIG. 5, base plate 52 may be provided with cut-outs 60 which allow access to O-ring 54. Referring to FIG. 6, pivoting dogs 56 are rigid, L-shaped, and pivot around a pivot 62. Pivoting dogs 56 have a first arm 64 and a second arm 66. Second arm 66 has a second engagement surface 68 that is designed to contact first engagement surface 48. Referring to FIGS. 5 and 6, second engagement surface 68 may be curved, in order to lay flush against first engagement surface 48 (shown only in FIG. 6). Alternatively, both of first and second engagement surfaces 48 and 68, respectively, may have other shapes that allow them to fit one another. Referring to FIG. 6, second engagement surface 68 has an upper end 70 and a lower end 72, such that upper end 70 extends closer to a center 74 (shown in FIG. 5) of base plate 52 than lower end 72. Referring to FIG. 3, this ensures that when first engagement surface 48 is in contact with second engagement surface 68, male member 32 cannot be removed from female coupler 28. Alternatively, in an embodiment not shown in the figures, upper end 70 could be positioned at the same distance as, or further from center 74 (shown in FIG. 5) then lower end 72. In this case, it should be understood that second arm 66 would prevent male member 32 from being removed upon insertion by latching against male member 32 at a position between base end 38 and first engagement surface 48. Because first engagement surface 48 has a wider circumference than male member 38, it would be impossible to remove male member 32 from locking seat 50 without removing O-ring 54. Referring to FIG. 6, O-ring 54 is positioned within an indent 76 of female coupler 28, such that O-ring 54 is in contact with first arm 64 of pivoting dogs 56. O-ring 54 biases second arm 66 up against a bottom 78 of base plate 52. Upon insertion of engaging end 40 of male member 32, pivoting dogs 56 pivot downwards, allowing male member 32 to engage female coupler 28. Referring to FIG. 3, once male member 32 is inserted fully, pivoting dogs snap upwards against bottom 78 of base plate 52, locking engaging end 40 of male member 32 in place.

Referring to FIG. 4, an example is shown of limited articulation between coupled first and second pigs 12 and 14, respectively. First pig 12 is shown as angled relative to second pig 14. Typically, this angling may occur at bends in a pipe (not shown). Pivoting ball 44 of male member 32 is shown pivoting within curved seat 36. Male member 32 can pivot around axis 46. Pivoting can occur when the biasing force of spring 34 is overcome. Additional pivoting is provided at engaging end 40 of male member 32. Because first engagement surface 48 is curved and sits within a partial curved seat 80 (shown in FIG. 5) that is created by each of second engagement surfaces 68, engaging end 40 is able to pivot around female coupler 28. Alternatively, female coupler 28 may be provided with a seat and ball assembly (not shown) separate from male member 32 that allows female coupler 28 to pivot around male member 32.

Referring to FIG. 1, male member 32 may be provided with latch ends 88 that engage a locking seat 84 of female coupler 28. Locking seat 84 has a channel 86 that male member 32 extends into, where latch ends 88 are forced to move inwardly during insertion into female coupler 28. Latch ends 88 have an angled surface 91 on their outer edge. Angled surface 91 is designed to wedge latch ends 88 inwards upon contact with locking seat 84. Locking seat 84 may have a guide surface 93 which is angled inwards in order to guide latch ends 88 into channel 86. Once latch ends 88 are extended beyond a locking shoulder 89 of locking seat 84, latch ends 88 spring outwardly to engage locking shoulder 89 as shown. This prevents male member 32 from being removed from locking seat 84. In the example shown in FIG. 1, male member 32 is bolted into first pig 12, and female coupler 28 is rigidly attached to second pig 14. The limited articulation afforded by this system is provided by the flexing of male member 32 under lateral strain.

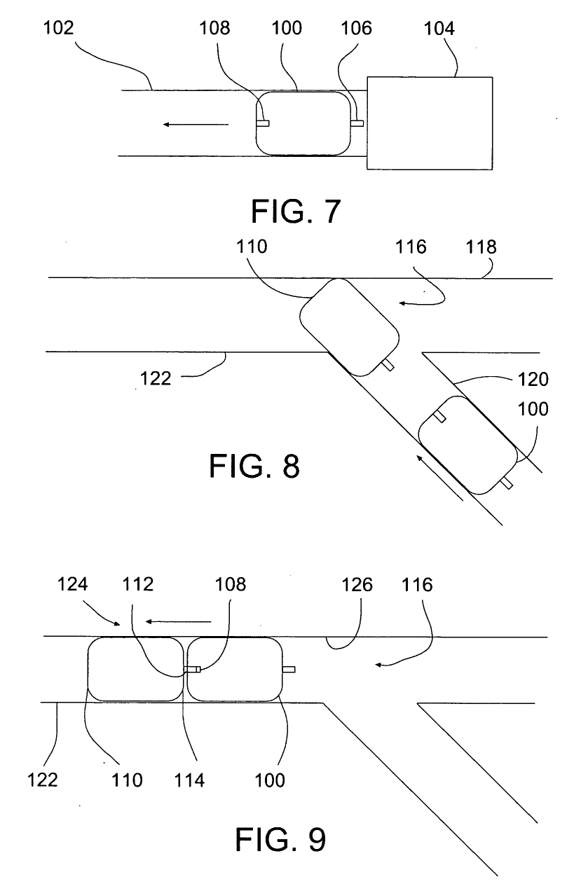

Referring to FIGS. 1 and 2, first and second pigs 12 and 14, respectively, may have any shape. In the examples shown, first and second pigs 12 and 14, respectively, have wings 90 that contact the walls (not shown) of a pipeline (not shown). It should be understood that the shape of pigs 12 and 14 is variable and can include any suitable design for pigs known in the prior art. An example of a simple design of a pig 100 is shown in FIGS. 7-9 incorporating no wings.

Operation:

Referring to FIG. 7, a pig 100 is shown being launched in a pipeline 102. Pig 100 may be launched by any conventional means described in the prior art, such as a pig launcher 104. Pig 100 has a male coupler 106 and a female coupler 108. Alternatively, pig 100 may only have one of couplers 106 and 108. Referring to FIG. 9, pig 100 is shown coupled to a leading pig 110. Leading pig 110 has a male coupler 112 positioned at its rear 114, such that male coupler 112 is coupled to female coupler 108. Alternatively, leading pig 110 may have a female coupler (not shown) positioned at rear 114, such that the female coupler couples to male coupler 112 of pig 100. Referring to FIG. 8, leading pig 110 is shown stuck at a junction 116 between a first pipeline 118, a second pipeline 120, and a third pipeline 122. Pig 100 has been launched down second pipeline 120, in order to couple with pig 110. Referring to FIG. 9, pig 100 has been coupled with pig 110, forming an articulated pig assembly 124. In order for pigs 110 and 100 to couple, both pigs 110 and 100 must contact each other within walls 126 of pipeline 120. When pigs 100 and 110 impact each other, they couple together. After coupling, pig 110 is jarred from its stuck position at junction 116, allowing articulated pig assembly 124 to continue travelling down third pipeline 122 along the direction indicated. It should be understood that articulated pig assembly 124 may consist of more than two pigs. By forming articulated pig assembly 124 within carrier pipeline 120, pigs 100 and 110 can be launched individually from pig launcher 104 (shown in FIG. 7) and coupled together after launching. This removes the requirement of a large and expensive multi-pig launcher (not shown) used to launch articulated pig assembly 124, as only one of pigs 100 and 110 need to be launched at a time. Additionally, it should be understood that both of pigs 100 and 110 may have all the same parts as described for either of the embodiments shown in FIG. 1 or 2 and described in detail above. The coupling of pigs 100 and 110 may occur by the same mechanism described below for the embodiments of FIGS. 1-6.

Referring to FIG. 6, male coupler 26 is shown prior to coupling with female coupler 28. Male coupler 26 is first positioned within hole 58, conical guide walls 59 directing engaging end 40 of male member 32 into hole 58. First engagement surface 48 comes into contact with upper end 70 of second engagement surface 68. The momentum of second pig 14 (shown in FIG. 2) ensures that male coupler 26 is able to overcome the biasing force of O-ring 54 on pivoting dogs 56, rotating second arm 66 downwards and allowing male member 32 enough clearance to pass into locking seat 50. Once male member 32 has progressed far enough within locking seat 50 such that first engagement surface 48 is clear of upper end 70, second arm 66 snaps upwards under the biasing force of O-ring 54. This allows second engagement surface 68 to neatly fit up against first engagement surface 48. Because upper end 70 of second engagement 68 extends beyond lower end 72, male member 32 is unable to be removed from locking seat 50. Referring to FIG. 4, both of pigs 12 and 14 are now free to pivot and articulate together throughout a pipeline. In order to remove male member 32 from locking seat 50 and thereby decouple first pig 12 from second pig 14, O-ring 54 must be removed. Referring to FIG. 2, hand indents 92 allow O-ring 54 (shown in FIG. 6) to be manually removed using tools or fingers (not shown). Referring to FIG. 3, once O-ring 54 is removed, second arm 66 of pivoting dogs 56 can be rotated far enough downwards such that male member 32 can be removed.

Referring to FIG. 1, coupling occurs when second pig 14 is moving towards first pig 12. Male member 32 is directed towards locking seat 84, and angled surface 91 of latch ends 88 comes into contact with guide surface 93 of locking seat 84. Guide surface 93 wedges latch ends 88 inwards towards each other, allowing latching ends 88 to squeeze into channel 86. Once latch ends 88 have progressed far enough down channel 86 such that latch ends 88 are clear of shoulder 89, latch ends 88 snap outwards, engaging shoulder 89 as shown. Male member 32 is now secured within locking seat 84, coupling first pig 12 to second pig 14. Limited articulation is allowed between first and second pigs 12 and 14, respectively, due to the flexing of male member 32. In order to de-couple first and second pigs 12 and 14, respectively, latch ends 88 must be squeezed, forcing latch ends 88 close enough together to allow male member 32 to be removed from channel 86.

### ADVANTAGES

The use of the method and the articulated pipeline pig assembly described above provides distinct advantages over other articulated pipeline pig assemblies. As pipeline pig assemblies, by definition, consist of more than one pipeline pig, a pipeline pig launcher must be used that is large enough to accommodate the entire pipeline pig assembly. Pipeline pig launchers of that size are relatively expensive. In contrast, small pipeline pig launchers are used to launch individual pipeline pigs in accordance with the present method and the pipeline pigs are coupled to form an assembly in the carrier pipe after launching. The physical detail shown of the pipeline pigs is not critical to the invention. Once the teachings of the method are known, various physical embodiments could be developed in accordance with the method.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiments without departing from scope of the Claims.

What is claimed is:

1. A method of coupling pipeline pigs to form an articulated pipeline pig assembly, comprising:
providing more than one pipeline pig, the more than one pipeline pig having couplers which couple upon impact and allow for limited articulation upon coupling;
launching each pipeline pig individually into a carrier pipe; and
bringing the more than one pipeline pig into contact within the carrier pipe after launching to cause the couplers on each pipeline pig to couple with another pipeline pig upon impact, thereby forming an articulated pipeline pig assembly of more than one pipeline pig.

2. An articulated pipeline pig assembly, comprising:
more than one pipeline pig having couplers which couple upon impact and allow for limited articulation upon coupling.

3. The articulated pipeline pig assembly of claim 2, wherein:
at least one pipeline pig has a female coupler with a locking seat and conical guide walls to guide a male coupler into mating engagement with the locking seat upon impact; and
at least one pipeline pig has a male coupler with a locking member which moves inwardly during insertion into the female coupler and then springs outwardly to engage the locking seat.

4. The articulated pipeline pig assembly of claim 3, wherein the locking member is a latch.

5. The articulated pipeline pig assembly of claim 2, wherein:
at least one pipeline pig has a female coupler with a locking seat and conical guide walls to guide a male coupler into mating engagement with the locking seat upon impact, the locking seat comprising pivotable dogs spring-biased into a locking position; and
at least one pipeline pig has a male coupler with a locking member which contacts the pivotable dogs, forcing them into an insertion position wherein the locking member can be inserted past the pivotable dogs, upon which the pivotable dogs are biased to rotate back into the locked position, the pivotable dogs contacting the locking member and preventing the locking member from being removed from the female coupler.

6. The articulated pipeline pig assembly of claim 2, wherein each of the couplers has a mounting ball and each of the more than one pipeline pig has a curved seat in which the mounted ball is received to permit limited articulation.

7. The articulated pipeline pig assembly of claim 2, wherein each male coupler has a male member with a base end and an engaging end, the male member having a mounting ball at each of the base end and the engaging end, and both of the male and female couplers have a curved seat, wherein the mounting ball at the base end is received by the curved seat of the male coupler and the mounting ball at the engaging end is received by the curved seat of the female coupler, in order to permit limited articulation about the base end and the engaging end.

8. The articulated pipeline pig assembly of claim 2, wherein the couplers include male couplers which are spring biased into an orientation along an axis of one of the more than one pipeline pig.
